(19) United States
(12) Patent Application Publication
(10) Pub. No.: US 2005/0160378 A1
(43) Pub. Date: Jul. 21, 2005

(54) Configuration display apparatus for computer, computer configuration display method, and computer configuration display program

(75) Inventor: Hirohisa Uchida, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/848,133

(22) Filed: May 19, 2004

(30) Foreign Application Priority Data
Jan. 20, 2004 (JP) 2004-011439

(51) Int. Cl. G06F 12/00

(52) U.S. Cl. 715/853

(57) ABSTRACT

The present invention provides a computer configuration display apparatus, a computer configuration display method, and a computer configuration display program that can contribute to reduction of a burden on a system administrator who performs management concerning physical components and logical components of a computer. The computer configuration display apparatus includes: a hierarchical data association unit that associates physical hierarchical data, which defines plural physical components of a computer as plural hierarchical data according to a predetermined physical segmentation, and logical hierarchical data, which defines plural logical components of the computer as plural hierarchical data according to a predetermined logical segmentation, with each other; a hierarchical data setting unit that sets the associated physical hierarchical data and logical hierarchical data; and a hierarchical data display unit that displays the physical hierarchical data and the logical hierarchical data set in the hierarchical data setting unit.

### BACKGROUND OF THE INVENTION

1. Field of the Invention

The present invention relates to a computer configuration display apparatus, a computer configuration display method, and a computer configuration display program.

2. Related Background Art

Conventionally, management work for a computer has problems as described below (e.g., see pages 5 to 8 and FIG. 1 of Japanese Patent Application Laid-Open No. 2001-282632, pages 2 to 4 and FIG. 1 of Japanese Patent Application Laid-Open No. 11-212826, and pages 4 to 11 and FIG. 1 of Japanese Patent Application Laid-Open No. 10-294731).

In a computer system that is required to operate stably for 24 hours in 365 days, in the event that a physical component of a computer or a logical component from the viewpoint of an OS installed in the computer has fallen into a state that adversely affects the computer (an error or the like), a cause for the component having fallen into the state has to be specified and removed.

Moreover, in order to grasp what kind of situation the computer is brought into by the state, it has to be specified which range of a physical configuration and a logical configuration of the computer is affected by the state.

It may take time to specify a cause of the state, for example, in the case in which the physical configuration or the logical configuration of the computer is complicated.

In addition, it may be difficult to judge which of the physical component and the logical component has caused the state because, conventionally, the physical configuration and the logical configuration of the computer are not clearly divided. Moreover, it may take time to specify which range of the physical configuration and the logical configuration is affected by this state.

Such work, which specifies a cause of the state and an range of the physical configuration and the logical configuration to be affected by the state, is required to be carried out promptly in order to prevent processing efficiency in the computer from falling. This is a burden for a system administrator.

### SUMMARY OF THE INVENTION

The present invention has been devised in order to solve the above-described problems, and it is an object of the present invention to provide a computer configuration display apparatus, a computer configuration display method, and a computer configuration display program that can contribute to reduction of a burden on a system administrator who performs management concerning physical components and logical components of a computer.

In order to solve the problems, a computer configuration display apparatus in accordance with the present invention is characterized by including: a hierarchical data association unit that associates physical hierarchical data, which defines plural physical components of a computer as plural hierarchical data according to a predetermined physical segmentation, and logical hierarchical data, which defines plural logical components of the computer as plural hierarchical data according to a predetermined logical segmentation, with each other; a hierarchical data setting unit that sets the associated physical hierarchical data and logical hierarchical data; and a hierarchical data display unit that displays the physical hierarchical data and the logical hierarchical data set in the hierarchical data setting unit.

With such a constitution, a physical configuration and a logical configuration of the computer, which have not been clearly divided conventionally, can be managed as individual hierarchical data, and a correspondence relation between the physical hierarchical data and the logical hierarchical data can be grasped easily. This results in contributing to reduction of a burden on a system administrator who performs management concerning the physical components and the logical components of the computer. Note that the plural hierarchical data in this context are preferably hierarchical data of a tree structure.

In the computer configuration display apparatus as described above, it is also possible to include a storage unit that stores correspondence relation data defining the correspondence relation between the physical hierarchical data and the logical hierarchical data, wherein the hierarchical data association unit associates the physical hierarchical data and the logical hierarchical data with each other on the basis of the correspondence relation data.

In addition, in the computer configuration display apparatus as described above, it is preferable to include a state detection unit that detects states of the physical components and the logical components of the computer, wherein the hierarchical data display unit displays a component, for which a state is detected by the state detection unit, with the detected state reflected thereon, and displays components of hierarchies higher in order than a hierarchy, to which an arbitrary component belongs, with a state of the arbitrary component reflected thereon.

With such a constitution, a state of each component in the hierarchical data can be grasped easily. In addition, since a state of each component is reflected on components of hierarchies higher in order than a hierarchy to which the component belongs, the system administrator can specify a component, which has fallen into the state, easily by tracing down hierarchies while selecting a component, for which the state is displayed, among the components in the higher in order hierarchies.

In addition to the above, in the computer configuration display apparatus with the above-described constitution, the hierarchical data display unit may display a physical component and a logical component, which are associated with each other, with a state of one of the physical component and the logical component reflected on the other.

With such a constitution, for example, in the event that a state of an error or the like has occurs in a certain physical component, it can be easily grasped which component in logical hierarchical data this error will affect. It goes without saying that the state is also reflected on logical components of hierarchies higher in order than a hierarchy to which a logical component, on which the state is reflected in this way, belongs. Consequently, a system administrator can easily grasp a range to be affected by a state that has occurred in a certain component.

In addition, a computer configuration display program in accordance with the present invention is characterized by causing a computer to execute: a hierarchical data association step of associating physical hierarchical data, which defines plural physical components of a computer as plural hierarchical data according to a predetermined physical segmentation, and logical hierarchical data, which defines plural logical components of the computer as plural hierarchical data according to a predetermined logical segmentation, with each other; a hierarchical data setting step of setting the associated physical hierarchical data and logical hierarchical data; and a hierarchical data display step of displaying the physical hierarchical data and the logical hierarchical data set in the hierarchical data setting step.

As described above in detail, according to the present invention, it is possible to provide a computer configuration display apparatus, a computer configuration display method, and a computer configuration display program that can contribute to reduction of a burden on a system administrator who performs management concerning physical components and logical components of a computer.

### BRIEF DESCRIPTION OF THE DRAWINGS

In the accompanying drawings:

FIG. 1 is a functional block diagram for explaining a structure of a computer configuration display apparatus according to an embodiment of the present invention;

FIG. 2 is a diagram for explaining logical hierarchical data to be set in a hierarchical data setting unit;

FIG. 3 is a diagram for explaining physical hierarchical data to be set in the hierarchical data setting unit;

FIG. 4 is a diagram for explaining attributes inherent in components in logical hierarchical data and physical hierarchical data;

FIG. 5 is a diagram for explaining correspondence relation data that defines a correspondence relation between the physical hierarchical data and the logical hierarchical data;

FIG. 6 is a flowchart for explaining operations of the computer configuration display apparatus according to this embodiment;

FIG. 7 is a diagram for explaining processing for reflecting a state, which is detected by a state detection unit, on a component;

FIG. 8 is a diagram for explaining the processing for reflecting a state, which is detected by the state detection unit, on a component;

FIG. 9 is a diagram for explaining the processing for reflecting a state, which is detected by the state detection unit, on a component;

FIG. 10 is a diagram for explaining the processing for reflecting a state, which is detected by the state detection unit, on a component;

FIG. 11 is a diagram for explaining the processing for reflecting a state, which is detected by the state detection unit, on a component;

FIG. 12 is a diagram for explaining the processing for reflecting a state, which is detected by the state detection unit, on a component;

FIG. 13 is a diagram for explaining the processing for reflecting a state, which is detected by the state detection unit, on a component; and

FIG. 14 is a diagram for explaining the processing for reflecting a state, which is detected by the state detection unit, on a component.

### DETAILED DESCRIPTION OF THE PREFERRED EMBODIMENTS

An embodiment of the present invention will be hereinafter described with reference to the accompanying drawings.

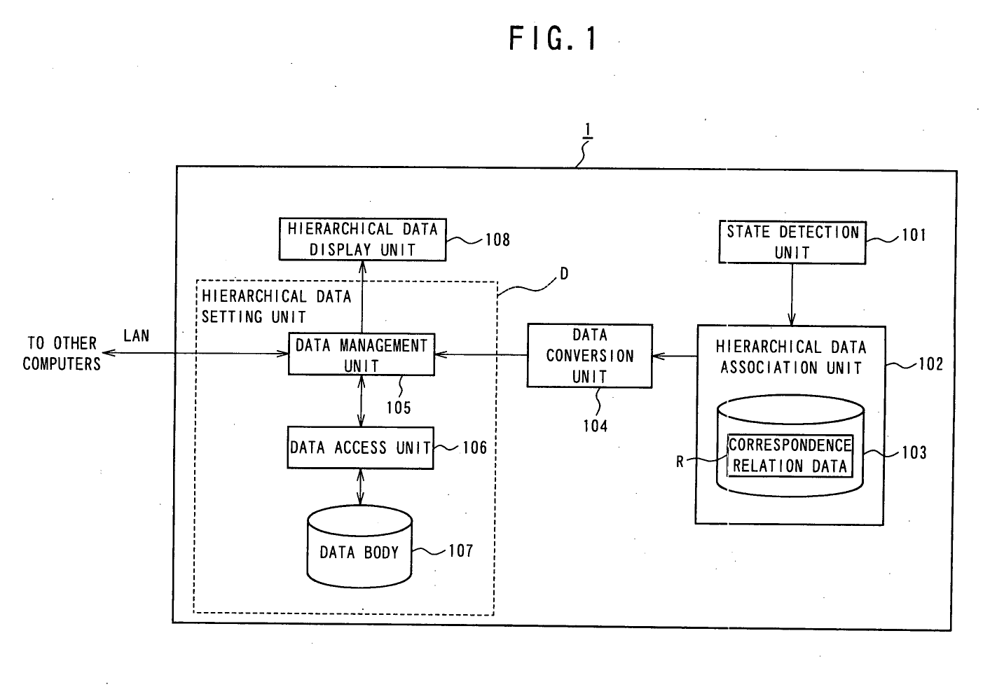

FIG. 1 is a functional block diagram for explaining a structure of a computer configuration display apparatus according to an embodiment of the present invention.

A computer configuration display apparatus 1 according to the present embodiment is an apparatus that, in order to perform management of a computer having plural physical components and logical components, performs display concerning components of the computer. Here, the computer configuration display apparatus 1 is arranged inside the computer.

The computer configuration display apparatus 1 includes a state detection unit 101, a hierarchical data association unit 102, a data conversion unit 104, a hierarchical data setting unit D, a hierarchical data display unit 108, a not-shown storage area, and a not-shown CPU.

The hierarchical data association unit 102 plays a role of creating various data concerning a computer to be managed. For example, the hierarchical data association unit 102 associates physical hierarchical data, which defines plural physical components of a computer as plural hierarchical data according to a predetermined physical segmentation, and logical hierarchical data, which defines plural logical components of the computer as plural hierarchical data according to a predetermined logical segmentation, with each other. Note that details of the physical hierarchical data and the logical hierarchical data will be described later.

The state detection unit 101 plays a role of detecting states of the physical components and the logical components of the computer. The states in this context include abnormalities (errors), which occur in the physical components (hardware) or the logical components (software), or changes to the physical components or the logical components. Note that in the event that a state of an error or the like is detected in the state detection unit 101, the state detection unit 10 sends information on the state to the hierarchical data association unit 102.

The data conversion unit 104 plays a role of converting data such as hierarchical data, which is associated by the hierarchical data association unit 102, into a data format that can be stored in a data body 107.

The hierarchical data setting unit D is a database that sets (stores) the physical hierarchical data and the logical hierarchical data that are associated by the hierarchical data association unit 102.

The hierarchical data display unit 108 includes, for example, a CRT, a liquid crystal display, or the like, and is capable of displaying the physical hierarchical data and the logical hierarchical data that are set in the hierarchical data setting unit D.

In addition, the hierarchical data setting unit D includes: a data management unit 105 that requests a data access unit 106, which controls communication among the hierarchical data display unit 108, the data conversion unit 104, and the data body 107 (to be described later), to perform processing; a data access unit 106 that writes data in and reads data from the data body 107 and performs exclusion processing involved in the writing and the reading; and the data body 107 that stores the physical hierarchical data, the logical hierarchical data, and the like. The data body 107 is constituted by a storage area such as an HDD. Note that the data management unit 105 can be communicatably connected to a computer configuration display apparatus that is arranged in another computer different from the computer in which the computer configuration display apparatus 1 is arranged. The computer configuration display apparatus, which is arranged in another computer, has the same configuration as the computer configuration display apparatus 1 such that data management units of both the computer configuration display apparatuses can communicate with each other via an electric communication line (LAN, the Internet, etc.).

Consequently, the physical hierarchical data and the logical hierarchical data of the computer, in which the computer configuration display apparatus 1 is arranged, can be monitored by the hierarchical data display unit in another computer.

The storage unit 103 plays a role of storing correspondence relation data R that defines a correspondence relation between the physical hierarchical data and the logical hierarchical data. The hierarchical data association unit 102 associates the physical hierarchical data and the logical hierarchical data with each other on the basis of the correspondence relation data R. The storage unit 103 is constituted by a storage area such as a RAM, an HDD, or the like.

Note that, here, the hierarchical data setting unit D and the hierarchical data display unit 108 are arranged in the computer to be managed. However, the present invention is not limited to this structure. At least one of or both of the hierarchical data setting unit D and the hierarchical data display unit 108 may be arranged outside the computer.

Note that, in the case in which the hierarchical data display unit 108 displays hierarchical data, when the hierarchical data display unit 108 requests the data management unit 105 to acquire data, the data management unit 105 requests the data access unit 106 to acquire the data. The data access unit 106 acquires the data from the data body 107 and delivers the data to the data management unit 105. The data management unit 105 sends the received data to the hierarchical data display unit 108, which displays the received data on a screen.

Next, logical hierarchical data and physical hierarchical data to be set by the hierarchical data setting unit D will be described.

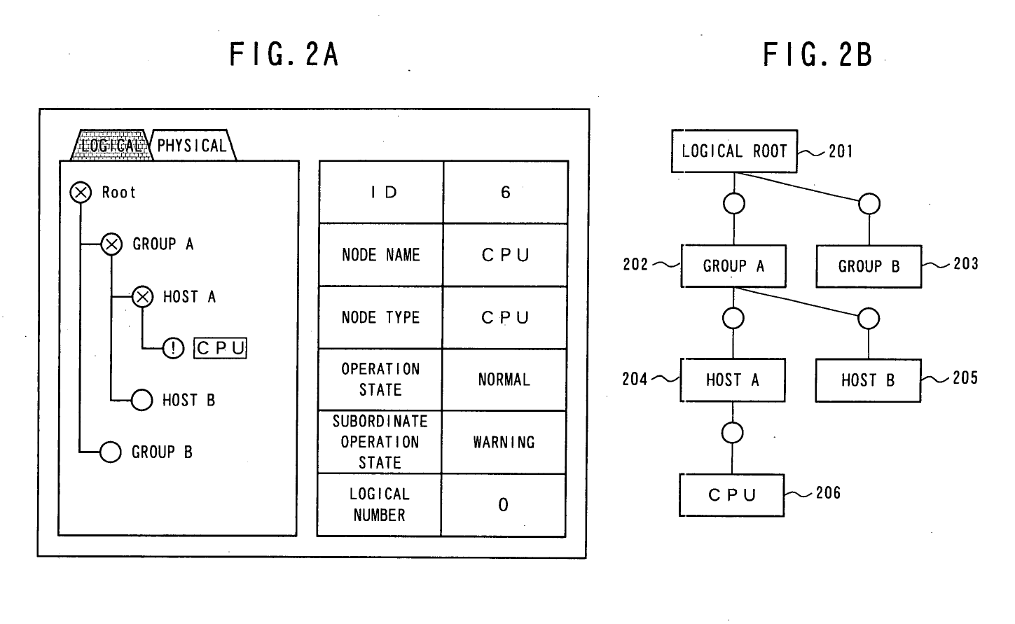

FIG. 2A shows an example of a display screen in the case in which logical hierarchical data to be set in the hierarchical data setting unit is displayed by the hierarchical data display unit 108. FIG. 2B is a conceptual diagram of an example of logical hierarchical data of the computer in which the computer configuration display apparatus 1 is arranged.

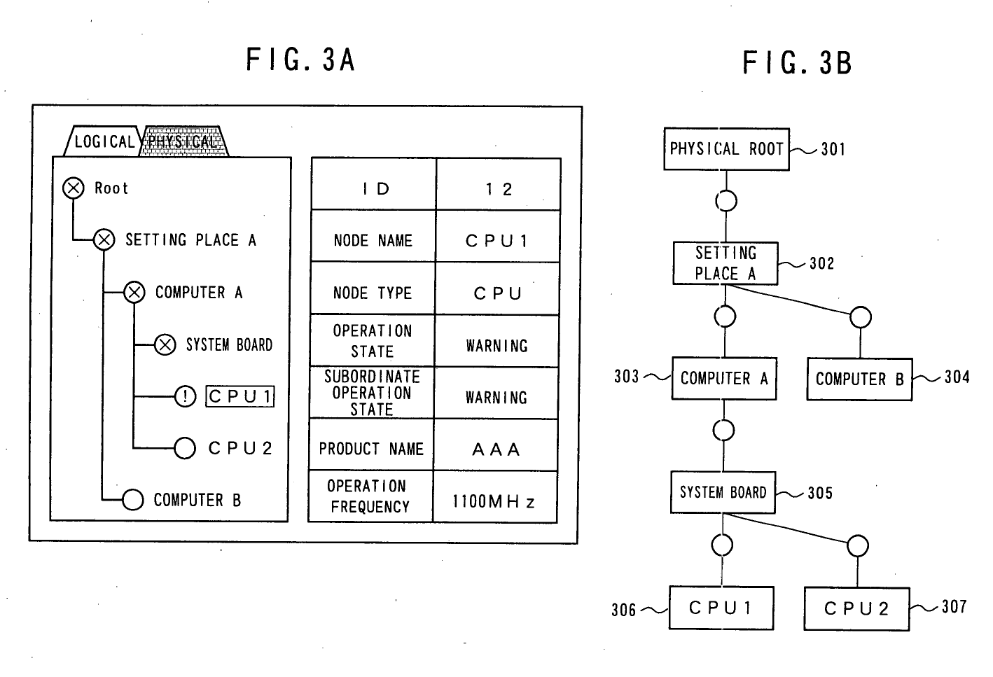

In addition, FIG. 3A shows an example of a display screen in the case in which physical hierarchical data to be set in the hierarchical data setting unit is displayed by the hierarchical data display unit 108. FIG. 3B is a conceptual diagram of an example of physical hierarchical data of the computer in which the computer configuration display apparatus 1 is arranged.

As shown in FIGS. 2B and 3B, the logical hierarchical data has a hierarchical tree structure constituted by plural logical components, and the physical hierarchical data has a hierarchical tree structure constituted by plural physical components.

As shown in FIGS. 2A and 3A, these hierarchical data are displayed by the hierarchical data display unit 108. In the hierarchical data that is displayed in a form of a tree in this way, the respective components constituting the hierarchical data are made selectable. The respective components constituting the hierarchical data have attribute data, which is information on the components. Attribute data of a selected component is displayed beside the tree display.

In addition, the physical hierarchical data and the logical hierarchical data, which are associated with each other by the hierarchical data association unit, are displayed by the hierarchical data display unit 108 such that the physical hierarchical data and the logical hierarchical data can be switched. Note that, when any one of the physical components is selected to switch display to the logical hierarchical data in a state in which the physical hierarchical data is displayed, all logical components corresponding to the selected physical component are displayed in a state in which the logical components are selected. Similarly, when display is switched to the physical hierarchical data in a state in which a logical component is selected, all physical components corresponding to the selected logical component are displayed in a state in which the physical components are selected.

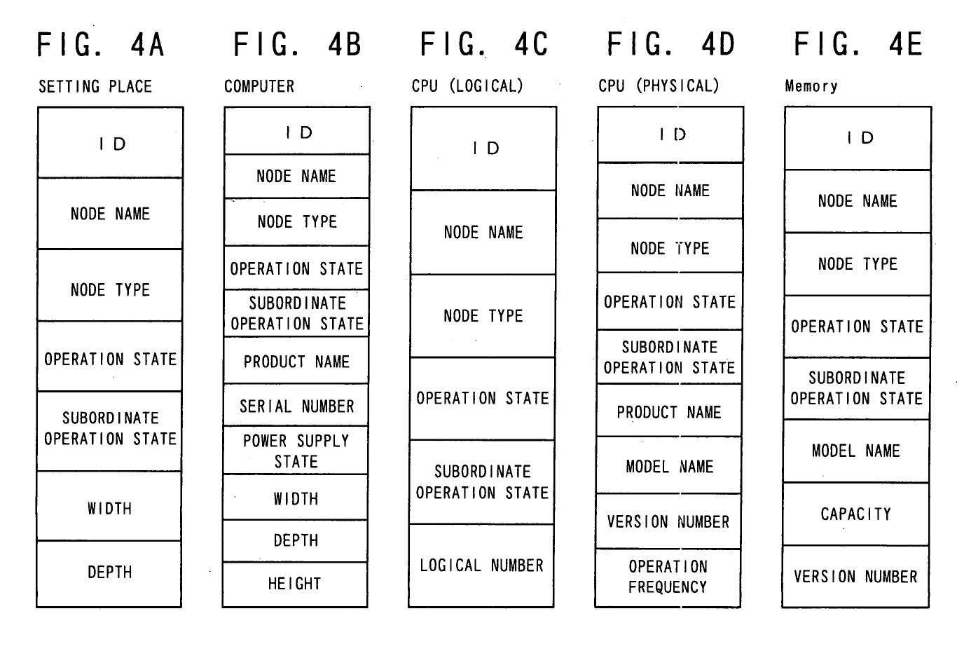

FIG. 4 shows an example of attributes inherent in components in logical hierarchical data and physical hierarchical data. Each component has attributes as data of a table format. Information to be stored in the table is different depending upon what the component represents.

FIG. 4A shows attribute data of a component “setting place” in the physical hierarchical data. The attribute data includes items “ID”, “node name”, “node type”, “operation state”, “subordinate operation state”, “width”, and “depth”.

FIG. 4B shows attribute data of a component “computer” in the physical hierarchical data. The attribute data includes items “ID”, “node name”, “node type”, “operation state”, “subordinate operation state”, “product name”, “serial number”, “power supply state”, “width”, “depth”, and “height”.

FIG. 4C shows attribute data of a component “CPU” in the logical hierarchical data. The attribute data includes items “ID”, “node name”, “node type”, “operation state”, “subordinate operation state”, and “logical number”.

FIG. 4D shows attribute data of a component “CPU” in the physical hierarchical data. The attribute data includes items “ID”, “node name”, “node type”, “operation state”, “subordinate operation state”, “product name”, “model name”, “version number”, and “operating frequency”.

FIG. 4E shows attribute data of a component “Memory” in the physical hierarchical data. The attribute data includes “ID, “node name”, “node type”, “operation state”, “subordinate operation state”, “model name”, “capacity”, and “version number”.

Among these attribute data items, “ID” means a value, which is determined uniquely, for identifying the component on a database, “node name” means a label name that is displayed when the attribute data is displayed in a form of a tree, “node type” means what the component represents (e.g., CabinetServer in the case of a computer, and CPU in the case of a CPU), “operation state” means an operation state of the component (normal, error, warning, etc.), and “subordinate operation state” means an operation state of a component subordinate to the component.

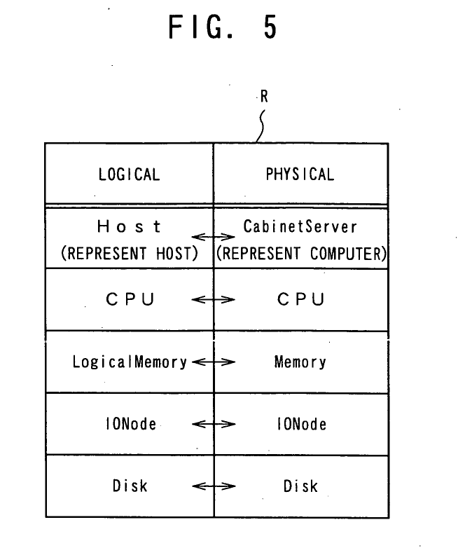

FIG. 5 is a diagram showing an example of the correspondence relation data R that defines a correspondence relation between physical hierarchical data and logical hierarchical data. In the correspondence relation data R in this context, Host, CPU, LogicalMemory, IONode, and Disk in the logical hierarchical data are associated with CabinetServer, CPU, Memory, IONode, and Disk in the physical hierarchical data, respectively. Note that the correspondence relation among the components is judged using node types. In other words, the figure shows a correspondence relation of node types that are defied as corresponding with each other among the logical components and the physical components.

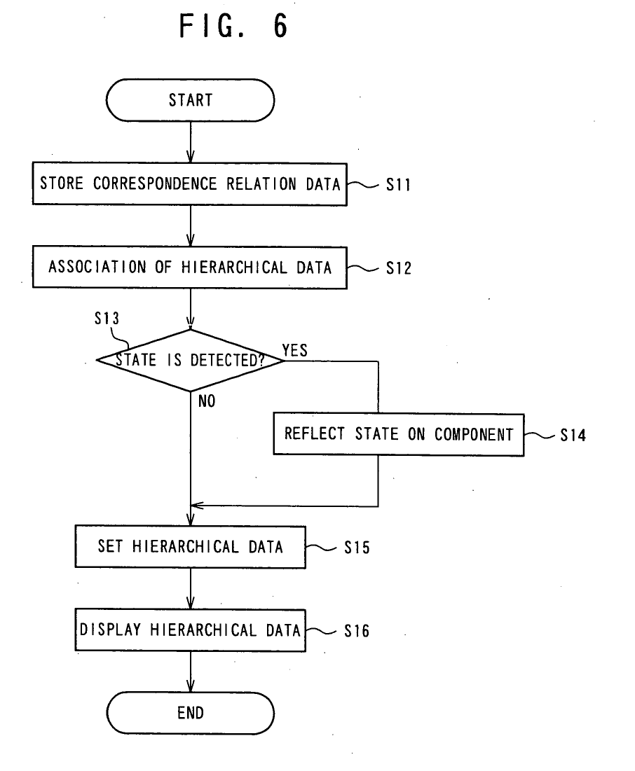

FIG. 6 is a flowchart for explaining operations of the computer configuration display apparatus according to this embodiment.

First, the correspondence relation data R, which defines a correspondence relation between physical hierarchical data and logical hierarchical data of a computer to be monitored, is stored in the storage unit 103 in advance (storage step) (S11).

Next, the physical hierarchical data and the logical hierarchical data of the computer are associated with each other by the hierarchical data association unit 102 on the basis of the correspondence relation data R (hierarchical data association step) (S12).

Subsequently, states (presence or absence of an error or warning, etc.) of physical components and logical components of the computer are detected by the state detection unit 101 (state detection step) (S13).

Here, if some state has been detected (S13, Yes), the detected state is reflected on a component for which the state is detected by the state detection unit 101 (S14). Note that, as processing for reflecting the detected state, a flag representing the state may be set for data concerning the component by the hierarchical data association unit 102, or the state may be reflected on the component when the data is displayed on a screen in a hierarchical data display step to be described later.

After reflecting the detected state (S14), or if no state has been detected (S13, No), the physical hierarchical data and the logical hierarchical data, which are associated by the hierarchical data association unit 102, are set (stored) by the hierarchical data setting unit D (hierarchical data setting step) (S15).

Then, the physical hierarchical data and the logical hierarchical data set in the hierarchical data setting unit D are displayed by the hierarchical data display unit 108 (hierarchical data display step) (S16).

As described above, a computer configuration display method according to this embodiment includes: a hierarchical data association step of associating physical hierarchical data, which defines plural physical components of a computer as plural hierarchical data according to a predetermined physical segmentation, and logical hierarchical data, which defines plural logical components of the computer as plural hierarchical data according to a predetermined logical segmentation, with each other; a hierarchical data setting step of setting the associated physical hierarchical data and logical hierarchical data; and a hierarchical data display step of displaying the physical hierarchical data and the logical hierarchical data set in the hierarchical data setting step.

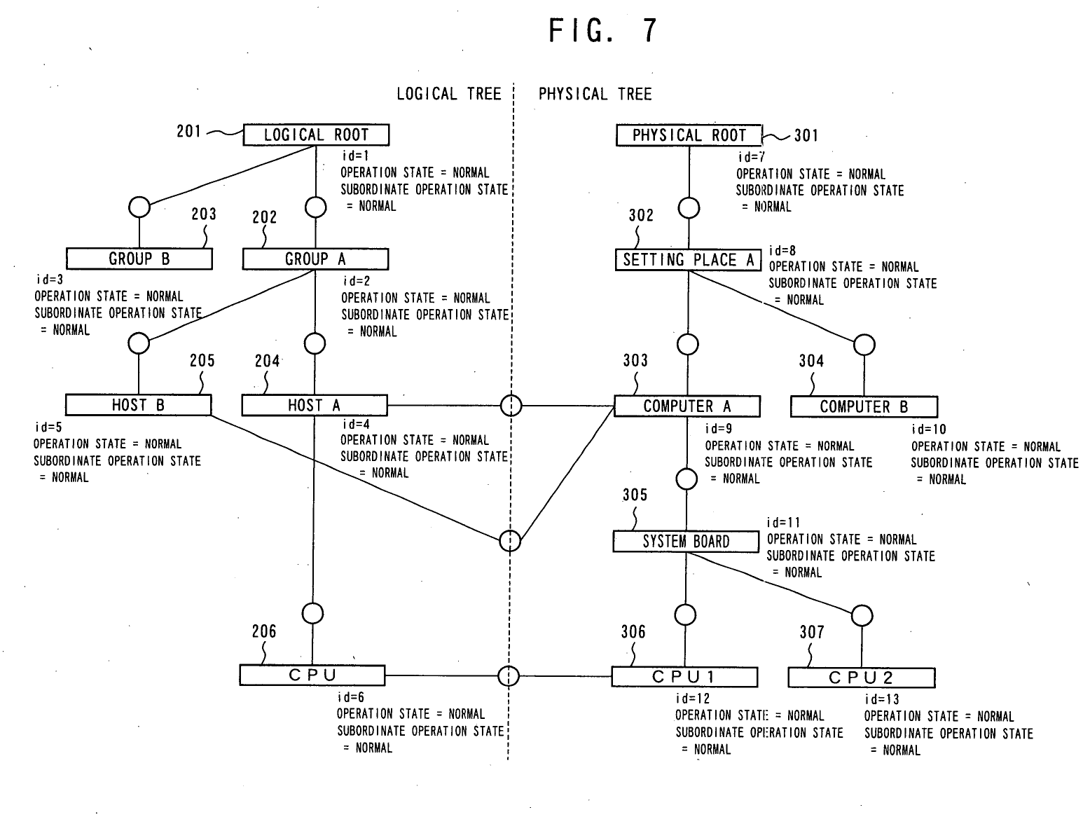

With reference to FIGS. 7 to 14, details of processing for reflecting a state of a certain component detected by the state detection unit on other components will be hereinafter described.

FIG. 7 shows an example of a conceptual diagram of physical hierarchical data and logical hierarchical data of a computer that are associated with each other by the hierarchical data association unit 102. The figure shows an initial state in which a state of an error or the like is not detected by the state detection unit 101.

In the figure, logical hierarchical data and physical hierarchical data are constituted by data holding objects (hereinafter, nodes), which hold data (the attribute data, etc. shown in FIG. 4), and connection objects, which represent connection relations among the data holding objects. The data holding objects correspond to the components. Here, the data holding objects are represented by squares, and the connection objects are represented by circles.

The connection objects hold information on nodes, which the objects are about to connect, and information on what kinds of connection relations the nodes will have. As the information representing the connection relations, there are “connection between physical components”, “connection between logical components”, “connection between a physical component and a logical component”, and the like.

The hierarchical data as shown in the figure is generated by processing described in (1) to (4) below. (1) The hierarchical data association unit 102 generates data and sends the data to the data conversion unit 104. (2) The data conversion unit 104 converts the data delivered from the hierarchical data association unit 102 into a form, which can be stored in the data body 107, and sends the data to the data management unit 105. (3) The data management unit 105 sends the data received from the data conversion unit 104 to the data access unit 106. (4) The data access unit 106 stores the data received from the data management unit 105 in the data body 107.

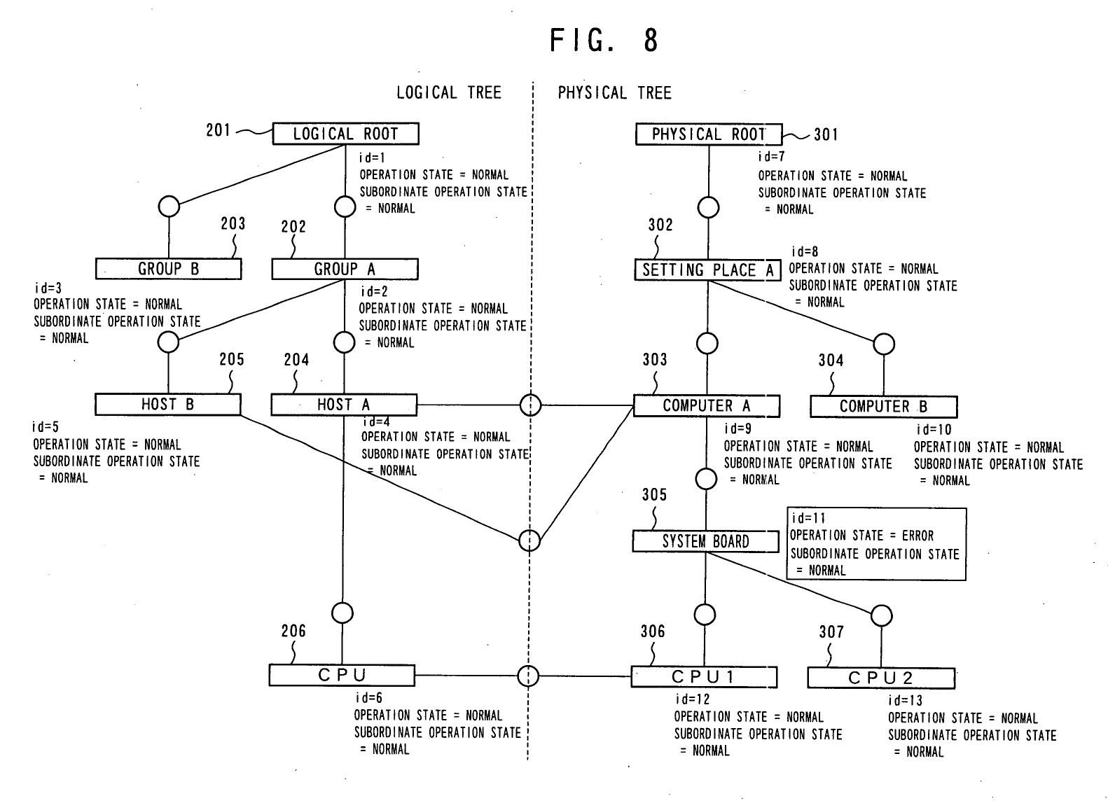

FIG. 8 shows a situation in which an error is detected as a state in a “system board” that is a component of physical hierarchical data (physical tree) by the state detection unit 101 (state detection step). As shown in the figure, the detected state “error” is reflected on an “operation state” of attribute data of the “system board”. This reflection processing for the “error” is performed by updating the attribute data of the component. Here, the hierarchical data association unit 102 performs update of the attribute data of the component (processing for reflecting the detected state) on the basis of information received from the state detection unit 101.

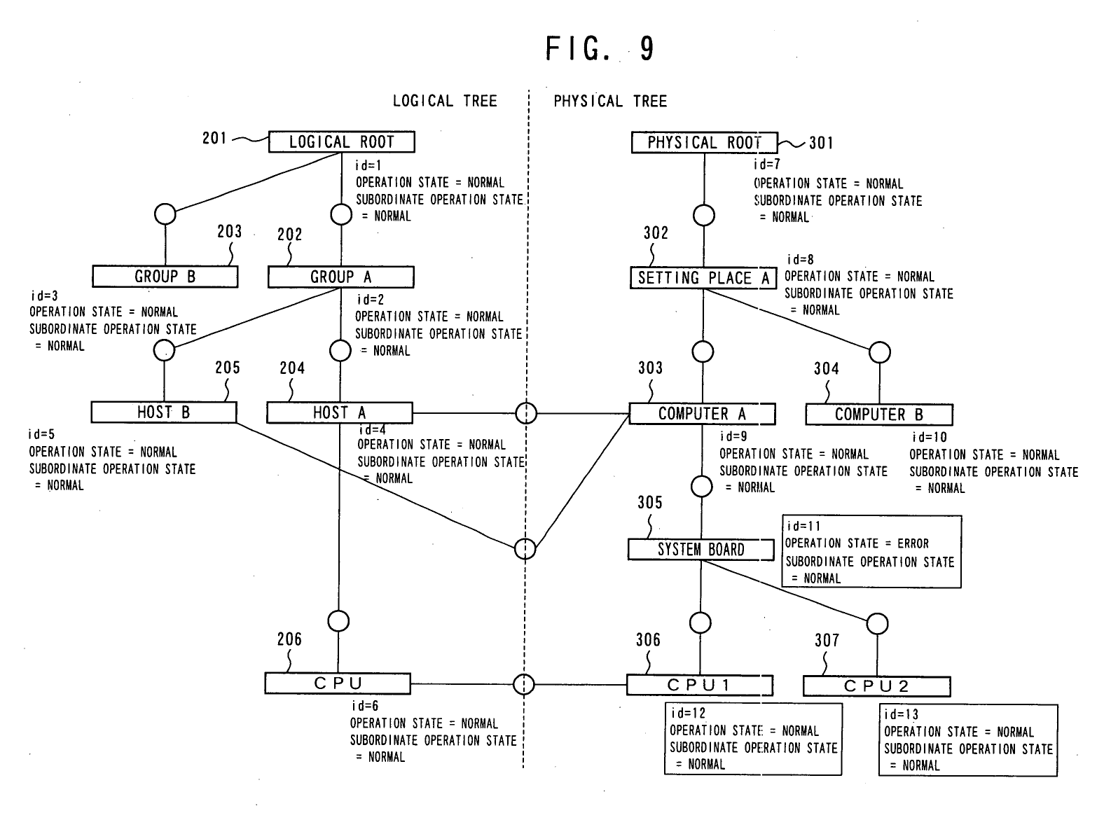

Next, as shown in FIG. 9, the operation state “error” detected in the “system board” and operation states of components (here, a CPU 1 and a CUP 2) lower in order than the “system board” in the tree are compared to determine a subordinate operation state in the attribute data of the “system board”. Here, since the operation states of the CPU 1 and the CPU 2 are normal, the subordinate operation state is “normal”.

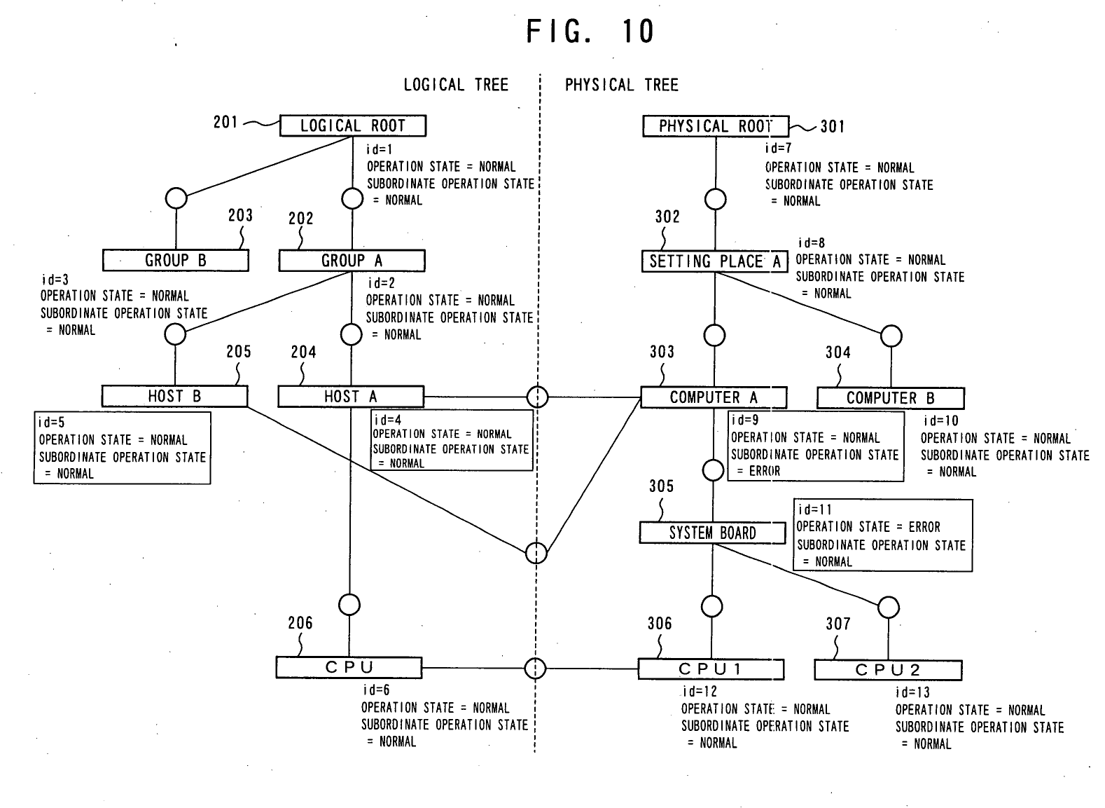

FIG. 10 shows propagation (reflection) of a state to components (a computer A, etc.) higher in order than the “system board” in the physical tree.

Here, since abnormality or the like of an operation state of the “computer A” itself has not been detected, an “operation state” of attribute data of the “computer A” is “normal”.

Next, a “subordinate operation state” of the attribute data of the “computer A” is determined on the basis of operation states of physical components lower in order than this “computer A” and operation states of logical components that are in a connection state with (associated with) the “computer A”. More specifically, the “operation state (error)” of the attribute data of the “system board” and an “operation state (normal)” of attribute data of a “host A” are compared, and an operation state with a higher in order degree of significance (here, error) is set as a “subordinate operation state” of attribute data of the “computer A”.

Note that, in order to perform propagation of a state in the logical tree, the “host A” and a “host B”, which are logical components associated with the “computer A”, are stored in a not-shown storage area as start points for propagation processing.

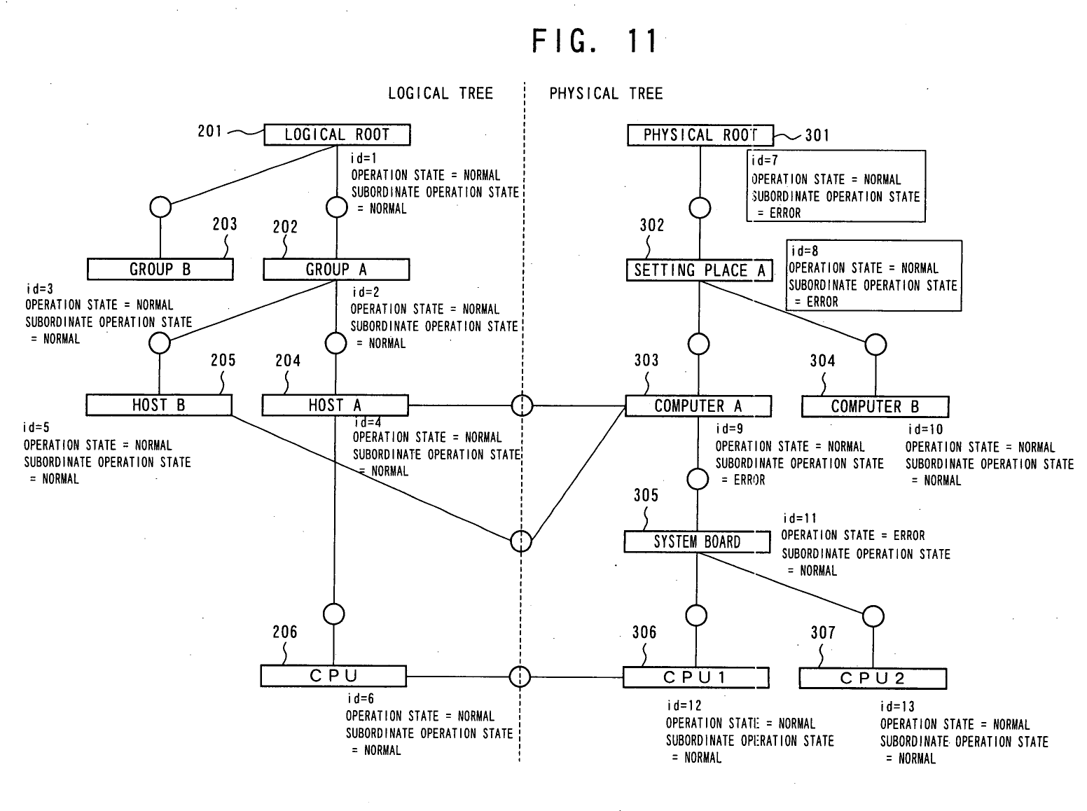

Subsequently, as shown in FIG. 11, the state “error”, which is reflected on the “subordinate operation state” of the attribute data of the “computer A”, is reflected on “subordinate states” of attribute data of a “setting place A” and a “physical Root (a top-level hierarchy of the physical tree)” that are physical components of a hierarchy higher in order than the “computer A”.

In other words, a component, for which a state is detected by the state detection unit, is displayed with the detected state reflected thereon, and components of a hierarchy higher in order than a hierarchy, to which an arbitrary component belongs, are displayed with a state of the arbitrary component reflected thereon.

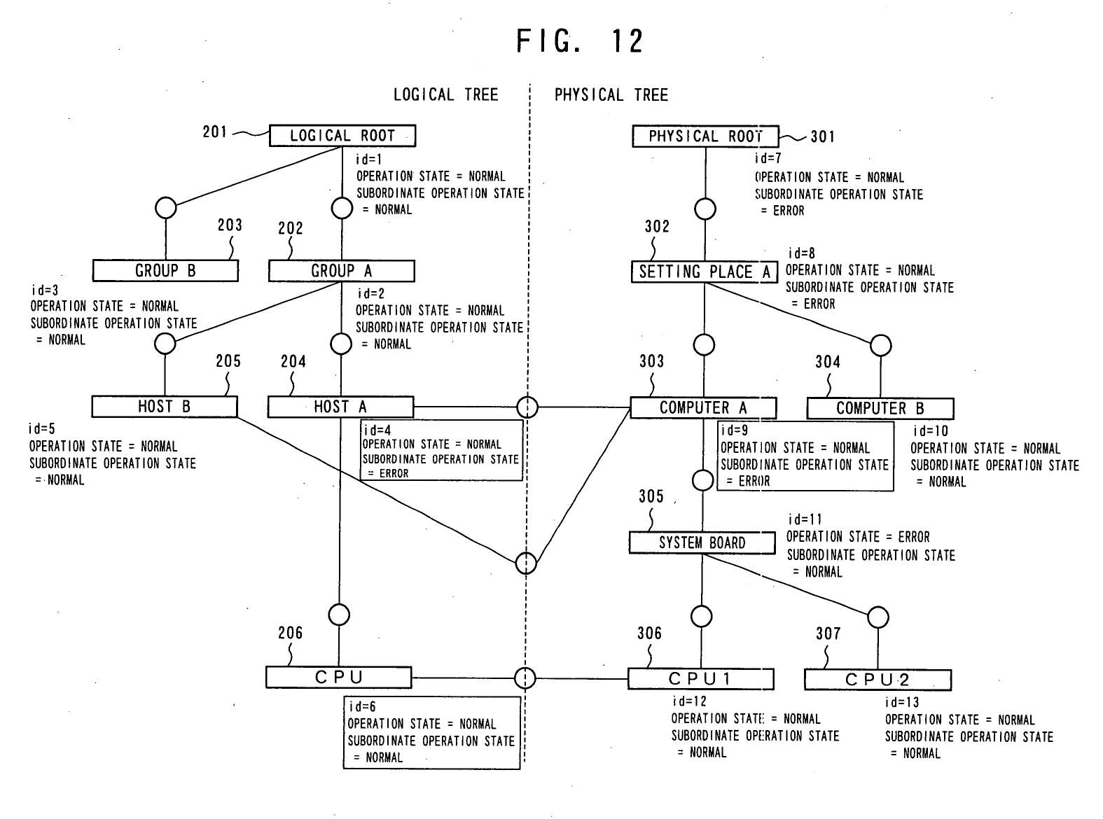

After completing the propagation (reflection) of the operation state in the physical tree, propagation of an operation state to components in the logical tree is performed. First, as shown in FIG. 12, propagation of the operation state to the components in the logical tree is performed with the “host A” as a start point. Here, the “subordinate operation state” of the “computer A”, which is a physical component in a connection relation with the “host A” and the “subordinate operation state” of the logical component “CPU” of a hierarchy subordinate to the “host A” are compared to determine a “subordinate operation state” in the attribute data of the “host A”. Here, the “subordinate operation state” in the attribute data of the “host A” is “error”. In other words, a physical component and a logical component, which are associated with each other, are displayed with a state of one of the physical component and a logical component reflected on the other. Thus, propagation processing for a state from the logical component to physical hierarchical data in the case in which an error or the like has occurred in the logical component can be performed in the same manner as described above.

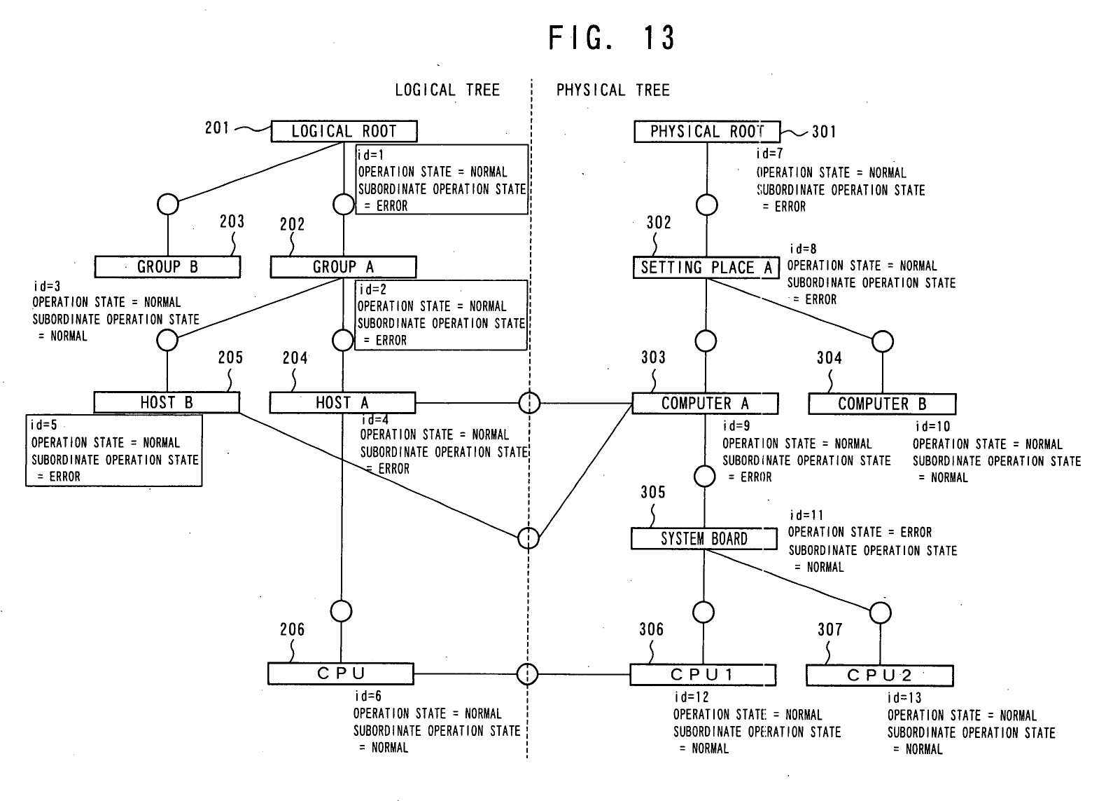

Next, as shown in FIG. 13, propagation of a state is also performed for logical components in hierarchies higher in order than the “host A”. Consequently, “subordinate operation states” in attribute data of a “group A” and a “logical Root” are “error”. Subsequently, propagation processing of an operation state is performed with the “host B”, which is stored as another start point, as a start point. Consequently, a “subordinate operation state” in attribute data of the “host B” is “error”.

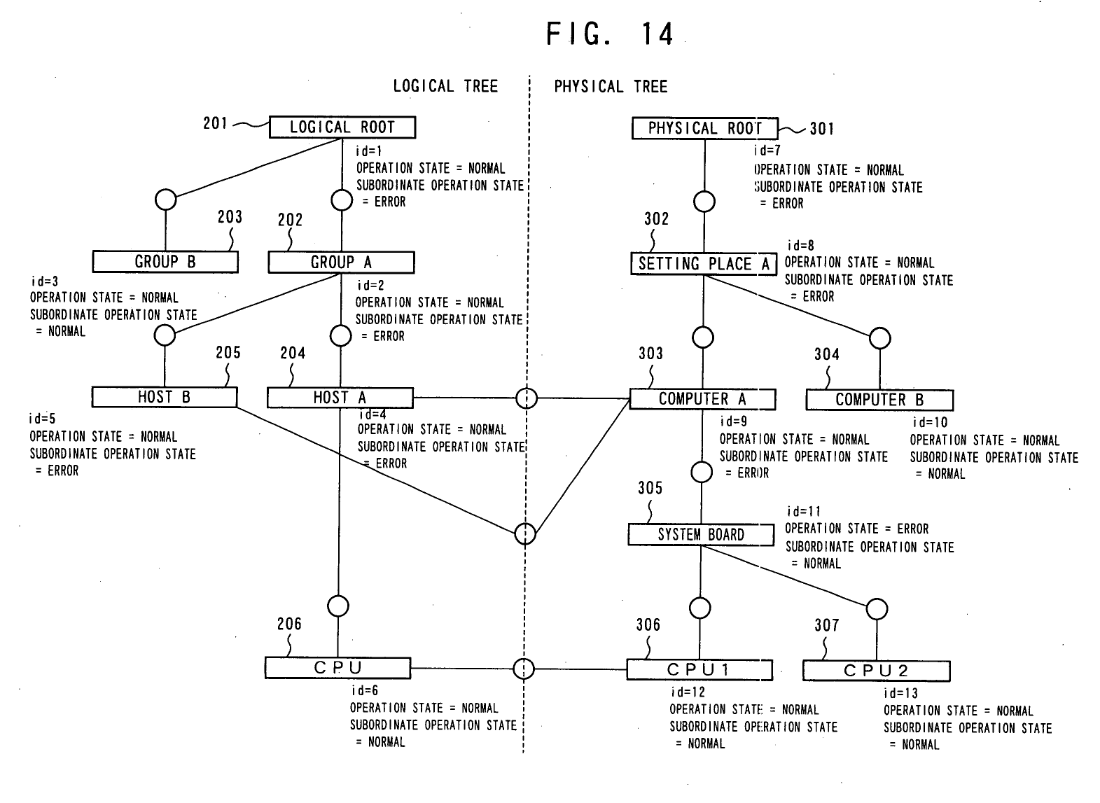

FIG. 14 shows a state in which propagation (reflection) processing for an error, which has occurred in the physical component “system board”, is completed. By performing such processing, it can be determined which range of the physical hierarchical data and the logical hierarchical data is affected by a state that has occurred in a certain component.

Consequently, it is easy to grasp which range of logical components in the logical hierarchical data is affected by an error or the like that has occurred in a physical component. In addition, it is easy to grasp which range of physical components in the physical hierarchical data is affected by the error or the like, which has occurred in a logical component, or to grasp which physical component is a cause of the error or the like. In other words, a source of occurrence of an error can be grasped in a short time, and it can be grasped in a short time which range of work is affected by the error.

As described above, attribute data inherent in each component holds information on two states, namely, a state of the node itself and a state of nodes of hierarchies lower in order than the node in a tree structure. A subordinate tree state is used when an error is represented on a tree, and a state of a node itself is used for confirmation of an error of the node itself. Consequently, it becomes possible to represent the state of the node itself and a range affected by the error separately.

As described above, the hierarchical data shown in FIGS. 7 to 14 indicate a concept of the hierarchical data stored in the hierarchical data setting unit D. It goes without saying that it is also possible to display the same image as shown in the figures on the hierarchical data display unit 108.

When the propagation processing for an operation state described above is performed, for example, the screen display as shown in FIGS. 2A and 3A is performed by the hierarchical data display unit 108. FIGS. 2A and 3A show a case in which some abnormality of an operation state has been detected for the “CPU 1” in the physical hierarchical data and the “CPU” in the logical hierarchical data by the state detection unit 101. Here, the detected abnormality of an operation state is represented as “warning”. Note that the abnormality of an operation state includes “warning”, “error”, and the like, which are represented by “!”, “X”, and the like on a tree display (see FIGS. 2A to 3B).

Note that the respective operations of the computer configuration display apparatus and the computer configuration display method according to this embodiment are realized by storing a computer configuration display program, which is stored in a not-shown storage area in the computer configuration display apparatus, in a recording medium readable by a computer (not-shown CPU) and causing the computer to execute the computer configuration display program. Note that, in the present invention, the recording medium readable by the computer includes portable recording media such as a CD-ROM, a flexible disk, a DVD disk, a magneto-optical disk, and an IC card, a database holding a computer program, or other computers and databases therefor, and also includes a transmission medium on a line.

More specifically, the computer configuration display program according to this embodiment is constituted to cause a computer to execute: a hierarchical data association step of associating physical hierarchical data, which defines plural physical components of a computer as plural hierarchical data according to a predetermined physical segmentation, and logical hierarchical data, which defines plural logical components of the computer as plural hierarchical data according to a predetermined logical segmentation, with each other; a hierarchical data setting step of setting the associated physical hierarchical data and logical hierarchical data; and a hierarchical data display step of displaying the physical hierarchical data and the logical hierarchical data set in the hierarchical data setting step.

In addition, in such a computer configuration display program, it is preferable to include a storage step of storing correspondence relation data that defines a correspondence relation between the physical hierarchical data and the logical hierarchical data, wherein the hierarchical data association step associates the physical hierarchical data and the logical hierarchical data on the basis of the correspondence relation data.

Moreover, in the computer configuration display program as described above, it is also possible to include a state detection step of detecting states of the physical components and the logical components of the computer, wherein the hierarchical data display step displays a component, for which a state is detected in the state detection step, with the detected state reflected thereon, and also displays components of hierarchies higher in order than a hierarchy, to which an arbitrary component belongs, with a state of the arbitrary component reflected thereon. Note that, in the hierarchical data display step, it is desirable to display a physical component and a logical component, which are associated with each other, with a state of one of the physical component and the logical component reflected on the other. In addition, the states in this context include abnormalities, which occur in the physical components or the logical components, or changes to the physical components or the logical components.

Note that, in the computer configuration display program as described above, the hierarchical data display step can display the physical hierarchical data and the logical hierarchical data, which are associated with each other in the hierarchical data association step, such that the physical hierarchical data and the logical hierarchical data can be switched.

1. A computer configuration display apparatus comprising:
a hierarchical data association unit that associates physical hierarchical data, which defines plural physical components of a computer as plural hierarchical data according to a predetermined physical segmentation, and logical hierarchical data, which defines plural logical components of the computer as plural hierarchical data according to a predetermined logical segmentation, with each other;
a hierarchical data setting unit that sets said associated physical hierarchical data and logical hierarchical data; and
a hierarchical data display unit that displays said physical hierarchical data and said logical hierarchical data set in said hierarchical data setting unit.

2. The computer configuration display apparatus according to claim 1, further comprising a storage unit that stores correspondence relation data defining a correspondence relation between said physical hierarchical data and said logical hierarchical data,
wherein said hierarchical data association unit associates said physical hierarchical data and said logical hierarchical data with each other on the basis of said correspondence relation data.

3. The computer configuration display apparatus according to claim 1, further comprising a state detection unit that detects states of said physical components and said logical components of the computer,
wherein said hierarchical data display unit displays a component, for which a state is detected by said state detection unit, with the detected state reflected thereon, and displays components of hierarchies higher in order than a hierarchy, to which an arbitrary component belongs, with a state of the arbitrary component reflected thereon.

4. The computer configuration display apparatus according to claim 3,
wherein said hierarchical data display unit displays a physical component and a logical component, which are associated with each other, with a state of one of said physical component and said logical component reflected on the other.

5. The computer configuration display apparatus according to claim 3,
wherein said states include abnormalities, which occur in said physical components or said logical components, or changes to said physical components or said logical components.

6. The computer configuration display apparatus according to claim 1,
wherein said hierarchical data display unit displays said physical hierarchical data and said logical hierarchical data, which are associated with each other by said hierarchical data association unit, such that said physical hierarchical data and said logical hierarchical data can be switched.

7. A computer configuration display method comprising:
a hierarchical data association step of associating physical hierarchical data, which defines plural physical components of a computer as plural hierarchical data according to a predetermined physical segmentation, and logical hierarchical data, which defines plural logical components of the computer as plural hierarchical data according to a predetermined logical segmentation, with each other;
a hierarchical data setting step of setting said associated physical hierarchical data and logical hierarchical data; and
a hierarchical data display step of displaying said physical hierarchical data and said logical hierarchical data set in said hierarchical data setting step.

8. The computer configuration display method according to claim 7, further comprising a storage step of storing correspondence relation data defining a correspondence relation between said physical hierarchical data and said logical hierarchical data,
wherein said hierarchical data association step associates said physical hierarchical data and said logical hierarchical data with each other on the basis of said correspondence relation data.

9. The computer configuration display method according to claim 7, further comprising a state detection step of detecting states of said physical components and said logical components of the computer,
wherein said hierarchical data display step displays a component, for which a state is detected in said state detection step, with the detected state reflected thereon, and displays components of hierarchies higher in order than a hierarchy, to which an arbitrary component belongs, with a state of the arbitrary component reflected thereon.

10. The computer configuration display method according to claim 9,
wherein said hierarchical data display step displays a physical component and a logical component, which are associated with each other, with a state of one of said physical component and said logical component reflected on the other.

11. The computer configuration display method according to claim 9,
wherein said states include abnormalities, which occur in said physical components or said logical components, or changes to said physical components or said logical components.

12. The computer configuration display method according to claim 7,
wherein said hierarchical data display step displays said physical hierarchical data and said logical hierarchical data, which are associated with each other in said hierarchical data association step, such that said physical hierarchical data and said logical hierarchical data can be switched.

13. A computer configuration display program that causes a computer to execute:
a hierarchical data association step of associating physical hierarchical data, which defines plural physical components of a computer as plural hierarchical data according to a predetermined physical segmentation, and logical hierarchical data, which defines plural logical components of the computer as plural hierarchical data according to a predetermined logical segmentation, with each other;
a hierarchical data setting step of setting said associated physical hierarchical data and logical hierarchical data; and
a hierarchical data display step of displaying said physical hierarchical data and said logical hierarchical data set in said hierarchical data setting step.

14. The computer configuration display program according to claim 13, further comprising a storage step of storing correspondence relation data defining a correspondence relation between said physical hierarchical data and said logical hierarchical data,
wherein said hierarchical data association step associates said physical hierarchical data and said logical hierarchical data with each other on the basis of said correspondence relation data.

15. The computer configuration display program according to claim 13, further comprising a state detection step of detecting states of said physical components and said logical components of the computer,
wherein said hierarchical data display step displays a component, for which a state is detected in said state detection step, with the detected state reflected thereon, and displays components of hierarchies higher in order than a hierarchy, to which an arbitrary component belongs, with a state of the arbitrary component reflected thereon.

16. The computer configuration display program according to claim 15,
wherein said hierarchical data display step displays a physical component and a logical component, which are associated with each other, with a state of one of said physical component and said logical component reflected on the other.

17. The computer configuration display program according to claim 15,
wherein said states include abnormalities, which occur in said physical components or said logical components, or changes to said physical components or said logical components.

18. The computer configuration display program according to claim 13,
wherein said hierarchical data display step displays said physical hierarchical data and said logical hierarchical data, which are associated with each other in said hierarchical data association step, such that said physical hierarchical data and said logical hierarchical data can be switched.
